(19) United States
(12) Patent Application Publication
(10) Pub. No.: US 2017/0185976 A1
(43) Pub. Date: Jun. 29, 2017

(54) METHODS, SYSTEMS, AND COMPUTER READABLE MEDIA FOR AN ELECTRONIC INFRASTRUCTURE FOR A ROTATING SAVINGS AND CREDIT ASSOCIATION

(71) Applicant: MasterCard International Incorporated, Purchase, NY (US)

(72) Inventors: Andres Guillermo Lopez, Yonkers, NY (US); Juan Carlos Leonardo Wiley Garcia, Ossining, NY (US); John Anthony Gioacchini, Yorktown Heights, NY (US); Bryan Jacob Wexler, Melville, NY (US); Stephen Anthony Parento, White Plains, NY (US)

(21) Appl. No.: 14/979,654

(22) Filed: Dec. 28, 2015

(51) Int. Cl. G06Q 20/10; G06Q 10/10

(52) U.S. Cl. CPC G06Q 20/102; G06Q 10/1097

(57) ABSTRACT

A computer system can be configured to execute an electronic payment infrastructure. In some examples, the system includes one or more computers, a rotating savings and credit association (ROSCA) establisher, and a ROSCA manager. The ROSCA establisher is configured for receiving, from a communications network, one or more establishment messages specifying user identifiers and storing, in a database, an electronic payment record for each user identifier. The ROSCA manager is configured for collecting, at each collection time specified by schedule data, an incoming payment for each user identifier using the electronic payment records stored in the database and providing, at each distribution time specified by the schedule data, an outgoing payment for a selected user identifier using the electronic payment record associated with the selected user identifier in the database. The outgoing payment is based on a sum of the incoming payments for the user identifiers.

### TECHNICAL FIELD

The subject matter described in this specification relates generally to computer systems executing an electronic payment infrastructure, e.g., for facilitating a rotating savings and credit association.

### BACKGROUND

Electronic payment infrastructures implemented on computer systems can be used for, e.g., sending payments from one person to another. For example, users of some conventional electronic payment systems can individually send payments to satisfy debts, e.g., incurred to a rotating credit association. A rotating credit association is an association formed by a group of participants who make contributions to a fund. A group organizer collects the contributions and distributes the contributions in whole or in part to each participant in rotation.

For example, a tanda is a form of a rotating savings and credit association (ROSCA) that is common in Mexico and is known among the Mexican American and Latino American community of southern California and various other parts of the southwestern United States. Tandas are used in some communities as a mechanism for savings and spending control. However, there is no known electronic infrastructure for implementing a tanda or other similar rotating savings and credit associating, requiring manual enrollment and enforcement of conditions by participants. Accordingly, there exists a need for an electronic infrastructure for a rotating savings and credit association.

### SUMMARY

A computer system can be configured to execute an electronic payment infrastructure. In some examples, the system includes one or more computers, a rotating savings and credit association (ROSCA) establisher, and a ROSCA manager. The ROSCA establisher is configured for receiving, from a communications network, one or more establishment messages specifying user identifiers and storing, in a database, an electronic payment record for each user identifier. The ROSCA manager is configured for collecting, at each collection time specified by schedule data, an incoming payment for each user identifier using the electronic payment records stored in the database and providing, at each distribution time specified by the schedule data, an outgoing payment for a selected user identifier using the electronic payment record associated with the selected user identifier in the database. The outgoing payment is based on a sum of the incoming payments for the user identifiers.

The subject matter described in this specification may be implemented in hardware, software, firmware, or any combination thereof. As such, the terms “function”, “node” or “module” as used herein refer to hardware, software and/or firmware components for implementing the feature(s) being described. In some examples, the subject matter described herein may be implemented using a non-transitory computer readable medium having stored thereon computer executable instructions that when executed by the processor of a computer cause the computer to perform steps.

Computer readable media suitable for implementing the subject matter described herein include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

FIG. 1 is a block diagram of an example environment in which a system of one or more computers is configured to execute an electronic payment infrastructure for sending and receiving messages on a packet-based network and storing electronic payment records in a database;

FIG. 2A is an illustration of an example GUI for creating a computer-implemented ROSCA;

FIG. 2B is an illustration of an example GUI for managing a computer-implemented ROSCA;

FIG. 3 is a block diagram illustrating an example outgoing payment for a computer-implemented ROSCA executed by a system of one or more computers using an electronic payment infrastructure;

FIG. 4 is a flow diagram of an example method for creating and managing a computer-implemented ROSCA using an electronic payment infrastructure.

### DETAILED DESCRIPTION

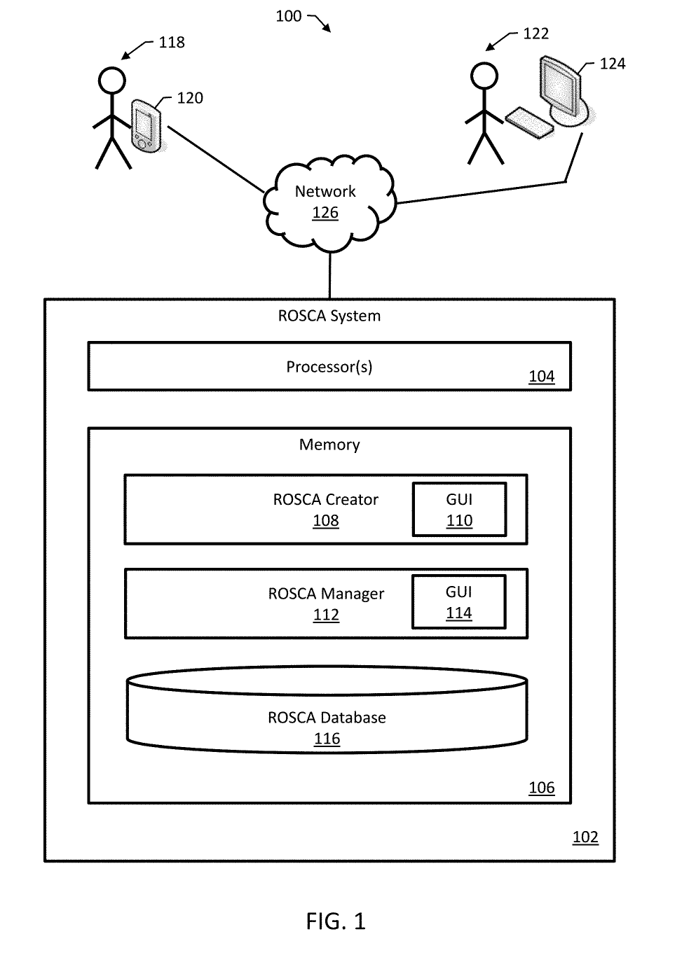

FIG. 1 is a block diagram of an example environment 100 in which a system of one or more computers is configured to execute an electronic payment infrastructure for sending and receiving messages on a packet-based network and storing electronic payment records in a database. Although a packet-based network is shown for illustrative purposes, the subject matter described herein is not limited to a packet-based network. Any type of communications network through which messages can be exchanged electronically between computing platforms may be used without departing from the scope of the subject matter described herein. Such networks may include packet-based networks, circuit-switched networks, and combinations of packet-based and circuit-switched networks.

Environment 100 includes a rotating savings and credit association (ROSCA) system 102 executing the electronic payment infrastructure. ROSCA system 102 is implemented by one or more computers, including one or more processors 104 and memory 106 storing executable instructions for processors 104 and other data. For example, processors 104 can load the executable instructions into random access memory (RAM) for execution.

The executable instructions include a ROSCA creator 108 and a ROSCA manager 112. ROSCA creator 108 is configured, by virtue of appropriate programming, for creating computer-implemented ROSCAs, and ROSCA manager 112 is configured, by virtue of appropriate programming, for managing computer-implemented ROSCAs created by ROSCA creator 108. ROSCA creator 108 stores data characterizing a ROSCA in a ROSCA database 116 stored in memory 104. ROSCA manager 112 uses the data stored in ROSCA database 116 to manage the ROSCAs.

In operation, ROSCA creator 108 sends a graphical user interface (GUI) 110 to a user device 120 over a packet-based data communications network 126. For example, a user 118 can enter, into a web browser executing on user device 120, a uniform resource locator (URL) for a web server executing on ROSCA system 102. User device 120 displays GUI 110, and user 118 enters information into GUI 110 for creating a ROSCA. User 118 can be a group organizer of the ROSCA. User device 120 can be any appropriate computer system and typically comprises a display, a user input device, and a network communications device. For example, user device 120 can be a personal computer, a mobile phone, a laptop computer, or a tablet computer.

User device 120, in executing GUI 110, sends establishment messages specifying user identifiers for participants in a ROSCA. For example, user 118 can enter names and email addresses of the participants in the ROSCA into GUI 110, and user device 120 can format and transmit the establishment messages to ROSCA system 102 over packet-based data communications network 126. ROSCA system 102 can then store the user identifiers in ROSCA database 116, e.g., by associating the user identifiers with a database record for the ROSCA. Packet-based data communications network 126 can be, e.g., a local area network, a virtual private network, the Internet, or a combination of computer networks.

User 118 can also enter schedule information into GUI 110, and user device 120 can then format and transmit establishment messages including the schedule information. For example, user 118 can enter a start date for collections in the ROSCA; a periodic interval for collections in the ROSCA, e.g., weekly, bi-weekly, or monthly; a start date for distributions in the ROSCA; and a periodic interval for distributions in the ROSCA.

User 118 can further enter additional information characterizing the ROSCA into GUI 110. User device 120 can format and transmit establishment messages including any additional information entered by user 118 into GUI 110. For example, user 118 can enter a collection amount to be collected on collection dates and a selection of a selection algorithm for selecting which of the participants is to receive distributions made on distribution dates.

ROSCA creator 108 can receive, over packet-based data communications network 126, payment information for each of the participants. For example, ROSCA creator 108 can send invitation messages to each of the participants, e.g., by sending a message over packet-based data communications network 126 to user device 124. The invitation messages can include, e.g., an email or text message with a URL for the ROSCA system 102. A user 122 who is a participant in the ROSCA can enter payment information into user device 124 which then formats and transmits a message to ROSCA system 102 over packet-based data communications network 126.

The payment information can include any appropriate information for carrying out a financial transaction, e.g., credit card information or routing and account numbers for a bank account. ROSCA system 102 extracts the payment information from the messages and stores the payment information in the ROSCA database 116, e.g., by associating payment information with records for user identifiers. The payment information can be transmitted using a secure communications protocol, e.g., secure socket layer over hypertext transfer protocol. The payment information can be protected within ROSCA database 116 using any appropriate protection technology for financial information, e.g., by encrypting the payment information.

In operation, ROSCA manager 112 administers the ROSCA by initiating electronic transfers at scheduled dates. ROSCA manager 112 periodically checks the current date against the scheduled dates and, on scheduled collection dates, collects incoming payments for each of the participants using the electronic payment records stored in ROSCA database 116. ROSCA manager 112 periodically checks the current date against the scheduled dates and, on scheduled distribution dates, selects a participant and provides an outgoing payment to the participant using the electronic payment record for the selected participant in ROSCA database 116.

ROSCA manager 112 selects the selected participant using a selection algorithm. The selection algorithm can be specified by the group organizer during creation of the ROSCA. The selection algorithm can be configured so that each participant is selected once before any participant is selected again.

For example, ROSCA manager 112 can maintain a list of not-yet-selected user identifiers that initially includes all of the user identifiers of all of the participants. ROSCA manager 112 can use a random or pseudo-random selection algorithm to select a participant and then, after providing an outgoing payment to that participant, remove the user identifier for that participant from the not-yet-selected list. When all of the participants have been selected, so that there are no user identifiers on the not-yet-selected list, ROSCA manager 112 repopulates the not-yet-selected-list with all of the user identifiers.

In another example, ROSCA manager 112 can select the selected participant using a selection schedule specifying a user identifier for each distribution time. For example, ROSCA manager 112 can select user identifiers in the order provided by the group organizer, or alphabetically by name or user identifier, or in any other appropriate kind of selection schedule. The selection schedule can be stored in the ROSCA database 116, e.g., by associating the selection with a record for the ROSCA in ROSCA database 116.

ROSCA manager 112 can also provide a GUI 114 for providing status information about a ROSCA to users 118 and 122. For example, users 118 and 122 can use web browsers executing on user devices 120 and 124 to load GUI 114 from ROSCA system 102 over packet-based data communications network 126. Users 118 and 122 can authenticate to ROSCA system 102, e.g., by providing user identifiers and passwords that match corresponding user identifiers and passwords stored in ROSCA database 116.

After authentication, GUI 114 can load and display status information on user devices 120 and 124. In some examples, the status information includes an account balance and a transaction history based on the incoming payments and the outgoing payments. In some examples, the status information includes a timing graphical indicator based on the schedule data and a selection graphical indicator based on the selection algorithm. GUI 114 can display any appropriate information about a ROSCA.

User 118 can also use GUI 114 to modify or delete data characterizing a computer-implemented ROSCA. For example, GUI 144 can be configured so that user 118 can add participants, delete participants, change the schedule information, change the selection algorithm, change the collection amount, and/or change the distribution amount. Changing the selection algorithm can be useful, e.g., when the participants all agree that the outgoing payment should be sent to one of the participants for a particular date, e.g., so that participant can use the payment to address a financial hardship.

ROSCA creator 108 and ROSCA manager 112 can improve the operation of computers executing an electronic payment infrastructure by reducing the amount of network traffic and processing load used compared to some conventional systems that required participants to log on and send individual payments to other participants at every collection time and distribution time. ROSCA system 102 can use ROSCA database 116 to reduce data storage requirements compared to some conventional systems by centralizing record keeping for a computer-implemented ROSCA that previously may have been stored in a distributed, unorganized manner by individual participants.

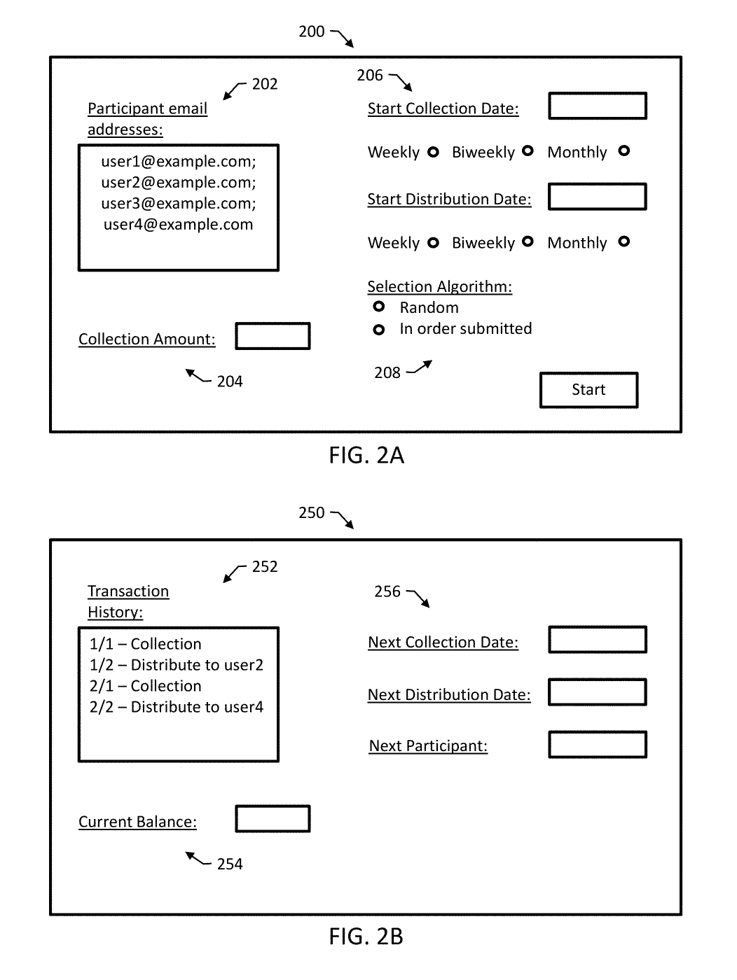

FIG. 2A is an illustration of an example GUI 200 for creating a computer-implemented ROSCA. GUI 200 can be sent by the ROSCA system 102 of FIG. 1 to the user device 122 of FIG. 1. GUI 200 can be implemented using any appropriate user interface technology, e.g., as one or more files of hypertext markup language (HTML) and digital images.

GUI 200 includes a user interface element 202 for a group organizer to enter user identifiers for participants in the ROSCA. As illustrated in FIG. 2, the user identifiers are email addresses and user interface element 202 is a text entry box. In some examples, the group organizer can enter different or additional information, e.g., by entering in names and phone numbers. GUI 200 also includes a user interface element 204 for entering a collection amount specifying a payment to be collected from each participant on each collection date. As illustrated in FIG. 2, user interface element 204 is a text entry box.

GUI 200 includes a user interface element 206 for entering schedule information. As illustrated in FIG. 2, user interface element 206 can include text boxes for entering a start collection date and a start distribution date and radio buttons for selecting an interval for collection and distribution dates. User interface element 206 can include any appropriate combination of user interface elements for entering schedule information, e.g., calendar widgets for the start collection date and start distribution date. GUI 200 also includes a user interface element 208 for choosing a selection algorithm for selecting which of the participants receives the outgoing payment on each distribution date. As illustrated in FIG. 2, user interface element 208 includes a radio button. User element 208 can be any appropriate user interface element for selecting or specifying a selection algorithm.

FIG. 2B is an illustration of an example GUI 250 for managing a computer-implemented ROSCA. GUI 250 can be sent by the ROSCA system 102 of FIG. 1 to the user device 122 of FIG. 1. GUI 250 can be implemented using any appropriate user interface technology, e.g., as one or more files of hypertext markup language (HTML) and images.

GUI 250 includes a user interface element 252 for displaying a transaction history and a user interface element 254 for displaying a current account balance. As illustrated in FIG. 2, user interface element 252 is a text box, and the transaction history shows collection dates, distribution dates, and user identifiers for participants receiving outgoing payments on distribution dates. User element 254 is a text box and can display a number indicating the current account balance, which may be greater than zero if a collection has occurred before a distribution or if a distribution is smaller than the sum of the incoming payments of a collection.

GUI 256 includes a user interface element 256 for displaying schedule information. As illustrated in FIG. 2, user interface element 256 includes text boxes for the next scheduled collection date, the next scheduled distribution date, and the next participate who will receive the outgoing payment on the next scheduled distribution date. User interface element 256 can include any appropriate user interface elements for displaying schedule information, e.g., calendar widgets.

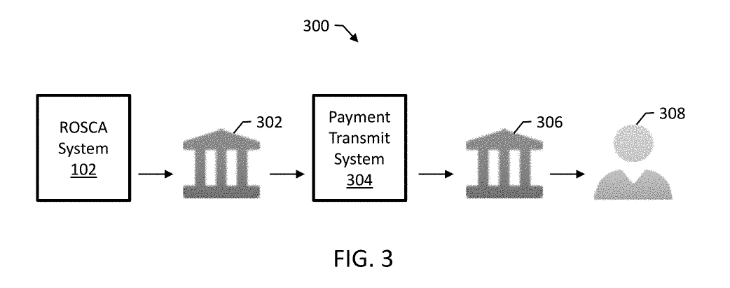

FIG. 3 is a block diagram illustrating an example outgoing payment for a computer-implemented ROSCA executed by a system of one or more computers using an electronic payment infrastructure. The ROSCA system 102 of FIG. 1 initiates the outgoing payment on a distribution date. The outgoing payment is based on a sum of collected incoming payments. For example, the outgoing payment can equal the sum of all of the collected incoming payments, so that the current balance of the ROSCA is zero after the outgoing payment. The outgoing payment can alternatively be another value based on the sum of the collected incoming payments, e.g., a percentage of the sum, so that the current balance increases with time.

ROSCA system 102 sends electronic packet-based messages to an originating institution computer system 302. Originating institution computer system 302, in response, sends electronic packet-based messages to a payment transmit computer system 304. Payment transmit computer system 304 is configured, by virtue of appropriate programming, to route packet-based messages carrying payment data between computer systems of financial institutions. Payment transmit computer system 304, in response, sends electronic packet-based messages to a receiving institution computer system 306. Receiving institution computer system 306 then executes a software routine to credit an account of a user 308 with the outgoing payment, e.g., by altering a record in a database for the account balance of user 308.

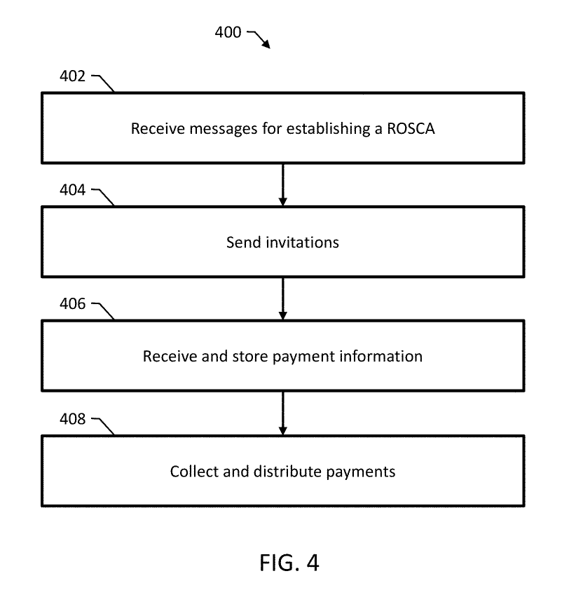

FIG. 4 is a flow diagram of an example method 400 for creating and managing a computer-implemented ROSCA using an electronic payment infrastructure. The method 400 is performed by a system of one or more computers configured, by virtue of appropriate programming, to send messages on a packet-based network and store electronic financial records in a database.

The system receives, from the packet-based network, one or more establishment messages specifying user identifiers for participants in the ROSCA (402). For example, the system can send, to a user device on the packet-based network, a GUI for display on the user device by sending one or more user interface messages specifying an establishment user interface for display to a group organizer. The system can then receive the establishment messages from the user device, e.g., as described above with reference to FIG. 1.

The establishment messages can include schedule information that specifies collection times by a collection start time and a periodic interval, and the schedule information can specify distribution times by a distribution start time and the same periodic interval or a different periodic interval. The establishment messages can include contact information for each user identifier.

The system sends, on the packet-based network, one or more invitation messages using the contact information for each of the participants (404). The participants respond by sending payment information. For example, each of the participants can create an account on the system and upload, over a secure communications channel, payment information to be used for the computer-implemented ROSCA.

The system receives and stores the payment information in electronic payment records in a database (406). The database can include a record for each participant include the participant's user identifier, contact information, authentication information, and payment information. Once the system receives payment information for all of the participants, the system can begin managing the computer-implemented ROSCA.

The system collects and distributes payments by collecting, at each collection time, an incoming payment from each participant using the electronic payment records stored in the database and by providing, at each distribution time, an outgoing payment based on a sum of the incoming payments (408). The system selects a participant to receive the outgoing payment for each distribution time using a selection algorithm, e.g., as described above with reference to FIG. 1.

Accordingly, while the methods, systems, and computer readable media have been described herein in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein.

Correspondingly, the subject matter as hereinafter claimed is intended to be broadly construed and interpreted, as including all such variations, modifications and alternative embodiments, within its scope and including equivalents of the claims. It is understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method performed by a system of one or more computers, the method comprising:
receiving, from a communications network, one or more establishment messages specifying a plurality of user identifiers;
storing, in a database, an electronic payment record for each user identifier of the plurality of user identifiers;
collecting, at each collection time of a plurality of collection times specified by schedule data, an incoming payment for each user identifier using the electronic payment records stored in the database;
providing, at each distribution time of a plurality of distribution times specified by the schedule data, an outgoing payment for a selected user identifier using the electronic payment record associated with the selected user identifier in the database, wherein the outgoing payment is based on a sum of the incoming payments for the user identifiers.

2. The method of claim 1, wherein the one or more establishment messages include the schedule information, and wherein the schedule information specifies the plurality of collection times by a collection start time and a periodic interval, and wherein the schedule information specifies the plurality of distribution times by a distribution start time and the periodic interval.

3. The method of claim 1, wherein receiving the one or more establishment messages specifying the plurality of user identifiers comprises:
sending, to a user device on the communications network, one or more user interface messages specifying an establishment user interface for display on the user device to a group organizer; and
receiving, from the user device displaying the establishment user interface, the one or more establishment messages.

4. The method of claim 1, wherein the one or more establishment messages specify, for each user identifier, contact information for the user associated with the user identifier, and wherein storing the electronic payment records comprises sending an invitation message for each user identifier using the contact information and receiving one or more payment information messages for each user identifier.

5. The method of claim 1, wherein the one or more establishment messages specify a selection algorithm for selecting, at each distribution time, the selected user identifier, and wherein providing the outgoing payment comprises selecting the selected user identifier using the selection algorithm, and wherein the selection algorithm is configured so that each user identifier is selected once before any user identifier is selected again.

6. The method of claim 1, wherein providing the outgoing payment comprises selecting the selected user identifier from a list of not-yet-selected user identifiers using a random or pseudo-random selection algorithm and removing the selected user identifier from the list of not-yet-selected user identifiers.

7. The method of claim 1, wherein providing the outgoing payment comprises selecting the selected user identifier using a selection schedule specifying a user identifier for each distribution time.

8. The method of claim 1, comprising authenticating a user device on the communications network using authentication information stored in the database and sending, to the user device on the communications network, one or more user interface messages specifying a status user interface for display on the user device.

9. The method of claim 8, wherein the status user interface is configured to display an account balance and a transaction history based on the incoming payments and the outgoing payments.

10. The method of claim 8, wherein the status user interface is configured to display a timing graphical indicator based on the schedule data and display a selection graphical indicator based on a selection algorithm used to select the selected user identifiers.

11. A system comprising:
one or more computers; and
a rotating savings and credit association (ROSCA) creator, implemented using the one or more computers, for receiving, from a communications network, one or more establishment messages specifying a plurality of user identifiers and storing, in a database, an electronic payment record for each user identifier of the plurality of user identifiers;
a ROSCA manager, implemented using the one or more computers, for collecting, at each collection time of a plurality of collection times specified by schedule data, an incoming payment for each user identifier using the electronic payment records stored in the database and providing, at each distribution time of a plurality of distribution times specified by the schedule data, an outgoing payment for a selected user identifier using the electronic payment record associated with the selected user identifier in the database, wherein the outgoing payment is based on a sum of the incoming payments for the user identifiers.

12. The system of claim 11, wherein the one or more establishment messages include the schedule information, and wherein the schedule information specifies the plurality of collection times by a collection start time and a periodic interval, and wherein the schedule information specifies the plurality of distribution times by a distribution start time and the periodic interval.

13. The system of claim 11, wherein receiving the one or more establishment messages specifying the plurality of user identifiers comprises:
sending, to a user device on the communications network, one or more user interface messages specifying an establishment user interface for display on the user device to a group organizer; and
receiving, from the user device displaying the establishment user interface, the one or more establishment messages.

14. The system of claim 11, wherein the one or more establishment messages specify, for each user identifier, contact information for the user associated with the user identifier, and wherein storing the electronic payment records comprises sending an invitation message for each user identifier using the contact information and receiving one or more payment information messages for each user identifier.

15. The system of claim 11, wherein the one or more establishment messages specify a selection algorithm for selecting, at each distribution time, the selected user identifier, and wherein providing the outgoing payment comprises selecting the selected user identifier using the selection algorithm, and wherein the selection algorithm is configured so that each user identifier is selected once before any user identifier is selected again.

16. The system of claim 11, wherein providing the outgoing payment comprises selecting the selected user identifier from a list of not-yet-selected user identifiers using a random or pseudo-random selection algorithm and removing the selected user identifier from the list of not-yet-selected user identifiers.

17. The system of claim 11, wherein providing the outgoing payment comprises selecting the selected user identifier using a selection schedule specifying a user identifier for each distribution time.

18. The system of claim 11, wherein the ROSCA manager is configured for authenticating a user device on the communications network using authentication information stored in the database and sending, to the user device on the communications network, one or more user interface messages specifying a status user interface for display on the user device.

19. The system of claim 18, wherein the status user interface is configured to display an account balance and a transaction history based on the incoming payments and the outgoing payments.

20. The system of claim 18, wherein the status user interface is configured to display a timing graphical indicator based on the schedule data and display a selection graphical indicator based on a selection algorithm used to select the selected user identifiers.

21. One or more non-transitory computer readable media storing instructions that, when executed by one or more computers, cause the one or more computers to perform operations comprising:
receiving, from a communications network, one or more establishment messages specifying a plurality of user identifiers;
storing, in a database, an electronic payment record for each user identifier of the plurality of user identifiers;
collecting, at each collection time of a plurality of collection times specified by schedule data, an incoming payment for each user identifier using the electronic payment records stored in the database;
providing, at each distribution time of a plurality of distribution times specified by the schedule data, an outgoing payment for a selected user identifier using the electronic payment record associated with the selected user identifier in the database, wherein the outgoing payment is based on a sum of the incoming payments for the user identifiers.
